(19) United States
(12) Patent Application Publication
(10) Pub. No.: US 2024/0344645 A1
(43) Pub. Date: Oct. 17, 2024

(54) No-Dig Repair of Transmission Pipelines

(71) Applicant: Mohammad Reza Ehsani, Tucson, AZ (US)

(72) Inventor: Mohammad Reza Ehsani, Tucson, AZ (US)

(21) Appl. No.: 18/134,568

(22) Filed: Apr. 14, 2023

(51) Int. Cl. F16L 55/165

(52) U.S. Cl. CPC F16L 55/1656; F16L 55/1654

(57) ABSTRACT

Methods and systems of no-dig repair of relatively narrow pipelines, with infrequent repair access points, are disclosed where multiple stitched or bonded layers of woven or nonwoven resin-saturated fabrics are wrapped around a partially deflated packer, which is pushed or pulled to the point of repair. At the point of repair, the packer is remotely inflated to push the stitched layers of fabric to the inside wall of the pipe and the pressure is sustained until the resin is cured or partially cured. Then the packer is deflated and retracted from the pipe. The fabric layers are stitched or bonded together in such a relative arrangement that each layer will overlap itself after the stitched layers are wrapped around and attached to the pipe.

### CROSS-REFERENCE(S) TO RELATED APPLICATION(S)

This Non-Provisional Patent Application is related to the U.S. Provisional Patent Application No. 63/330,754, entitled “Internal No-Dig Repair of Pipes,” filed on 13 Apr. 2022, the disclosure of which is hereby expressly incorporated by reference in its entirety and the benefit of its filing date is claimed under 35 U.S.C. § 119.

### TECHNICAL FIELD

This application relates generally to pipe repair and reinforcement. More specifically, this application relates to a method for no-dig repair and reinforcement of high-pressure gas-pipelines with infrequent maintenance access points.

### BRIEF DESCRIPTION OF THE DRAWINGS

The drawings, when considered in connection with the following description, are presented for the purpose of facilitating an understanding of the subject matter sought to be protected.

FIG. 1 shows an example of an arrangement of three layers of fabric to be used for the repair of a damaged pipe;

FIG. 2A illustrates example positions of the three layers of fabric of FIG. 1, wrapped around a deflated packer to be able to move inside a damaged pipe;

FIG. 2B illustrates the three layers of fabric of FIG. 2A when the packer is inflated and the layers are pushed against the damaged pipe;

FIG. 3 shows an example application for an oil and gas (O&G) and other fluid transmission pipe, where the access point is an inclined pipe;

FIG. 4 illustrates a sample system for repair of damaged pipes.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, although here the emphasis is placed on pipelines carrying hazardous materials such as oil and gas (O&G), the techniques and methods presented are equally applicable to all pipes carrying any gas or fluid such as hydrogen water, sewer, etc.

The US DOT's (Department of Transportation) Pipelines and Hazardous Materials Safety Administration (PHMSA) is the government entity responsible for guidelines for the design, construction, and maintenance of the nation's network of pipelines for conveyance of hazardous materials such as O&G. The energy transportation network of the United States consists of over 2.5 million miles of pipelines operated by approximately 3,000 companies (PHMSA, 2013). The network includes approximately 182,000 miles of hazardous liquid and carbon dioxide pipelines; 325,000 miles of onshore and offshore gas transmission and gathering systems pipelines; and 2,145,000 miles of gas distribution mains and services pipelines.

Most of these pipelines are old and prone to failure. PHMSA reports a total of 5,745 significant incidents with 282 deaths and 1,193 injuries in the 20-year period from 2000 through 2019. Moreover, these incidents cost over $10,419,000,000 in damages, a huge some to absorb by any industry. Corrosion in transmission pipes is the second leading cause of these incidents (PHMSA, 2019). Moreover, older and cracked pipes are a significant source of methane leaks, particularly from natural gas lines. Methane is the second most abundant anthropogenic Green House Gas (GHG) after carbon dioxide (CO₂), accounting for about 20 percent of global emissions. Methane is more than 25 times as potent as carbon dioxide at trapping heat in the atmosphere and leaky natural gas pipes are among the main culprits of methane emissions into the atmosphere.

The experience and data to date suggest there is a need for practical solutions to address pipeline leaks and failures in conveying hazardous fluids. A key aspect is identifying pipe segments with apparent leaks that are at high risk of failure, where the industry has made substantial progress. The next step is rehabilitating those pipe segments to stop leaks before they fail in a feasible and economical manner with minimal downtime or impact on operations.

Here a unique solution with thin and strong (particularly in tension) sheets of woven or unwoven materials such as SuperLaminate™ is disclosed; a carbon fiber-based composite point repair system that can be installed without excavation (no-dig). With the SuperLaminate™ technology, steel transmission and distribution O&G pipe failures can be prevented by performing repairs proactively upon detecting any signs of anomalies (corrosion/wall thinning, pitting, cracks, weld seam defects, and other signs of distress in the pipe) by pipeline inspection.

Sewer pipes have access points through manholes that are typically several hundred feet apart. They also operate under gravity flow or low-pressure conditions. These factors make their repair much easier and as a result there are numerous solutions in the market for repair of sewer pipes. The next level of complexity is for water pipes. These pipes operate under higher pressures (from 50 to 300 psi) and their access points are farther apart, perhaps thousands of feet. The disclosed innovation may be used for such repairs with zero excavation or cutting of trenches.

One of the techniques used for repairing sewer pipes is the steel sleeve. There are two major technical problems with this product. First, the rigid steel sleeve cannot pass through bends and angles that may be along the repair path (between the access point and the point of repair). Second, the modulus of elasticity of steel is very high. When the relatively stiff steel sleeve is bonded to the steel pipe, it does not allow a perfect composite action of the host pipe and the liner. Its relatively non-flexible nature also prevents full contact between the steel sleeve and the host pipe at 100% of the points. That is, the sleeve may bridge over some minor indentations or low-point profiles in the pipe. In contrast, the FRP solutions disclosed here overcome all these limitations.

A major challenge with the repair of O&G pipelines is that the access points for these pipes are typically thousands of feet apart. In most cases, there are launch and retrieve points for the pipe cleaning and condition assessment equipment, but these access points can often be 5 miles or farther apart. O&G transmission pipes also often operate at pressures higher than water pipelines. As such, the repair system must be made of strong materials (particularly in tension), able to reach long distances (2 miles or longer) away from the entry point, and provide the ability to be controlled remotely for deployment. Furthermore, there may be bends and angles present that would limit the use of rigid sleeves.

In this specification, a method for no-dig point repair of O&G pipes is disclosed. Those skilled in the field of pipeline repair and rehabilitation understand that there can be many variations of this approach while remaining within the spirit of the disclosed method and thus protected by this filing. Although pipes may be repaired from outside, those repairs require digging a trench around the pipe and exposing the pipe which adds significant cost and time to the project and, as such, it is not a desirable repair technique.

In many cases, the flow in the pipe may be stopped or bypassed and the pipe may be cleaned by mechanical or chemical means to remove any buildup or tuberculation from the interior surface of the pipe. Often, at this stage or prior to it, various condition assessments and non-destructive evaluation techniques are used to determine the areas where the pipe's integrity has been compromised. As a part of this operation, the exact coordinates of the damaged area in terms of distance measured from the entry point and the angle (from 0 to 360 degrees around the pipe) where the damage is located can be measured and documented.

The example SuperLaminate™ repair materials consist of Fiber Reinforced Polymer (FRP) products, where the fibers can be made from preferably nonmetallic materials such as glass, basalt, Kevlar, carbon, etc. These can be FRP fabrics saturated with resin or can be pre-cured laminates made with FRP products. Examples of such laminates have been used by QuakeWrap® in the repair of gas pipes.

In various embodiments the repair materials are wrapped around what is known as a packer to those skilled in the art. A packer is a flexible balloon-like, preferably stretched, device that can be inflated and deflated at will. Usually, packers are manufactured such that when inflated they expand to a certain diameter. So, one packer may be good for up to 12-inch diameter pipe, while a bigger one may be required for a 24-inch diameter pipe. The length of most packers is between 2 to 6 feet although shorter and longer packers can also be custom built.

In various embodiments, the FRP fabric is cut to length and saturated with resin. In some applications, it is preferred to use more flexible fabrics rather than pre-cured laminates as these flexible fabrics can easily negotiate bends that may be present in the pipeline. The number of layers and type and strength of each of the layers of the fabric must be designed and calculated by engineers to provide the necessary strength for resisting the required internal pressure and external load effects from soil overburden pressure, traffic, etc. Each of the several layers of fabric is placed in a specific position relative to other layers inside the host pipe. For this reason, a preferred technique has been developed for assembling the layers of fabric as discussed in detail below.

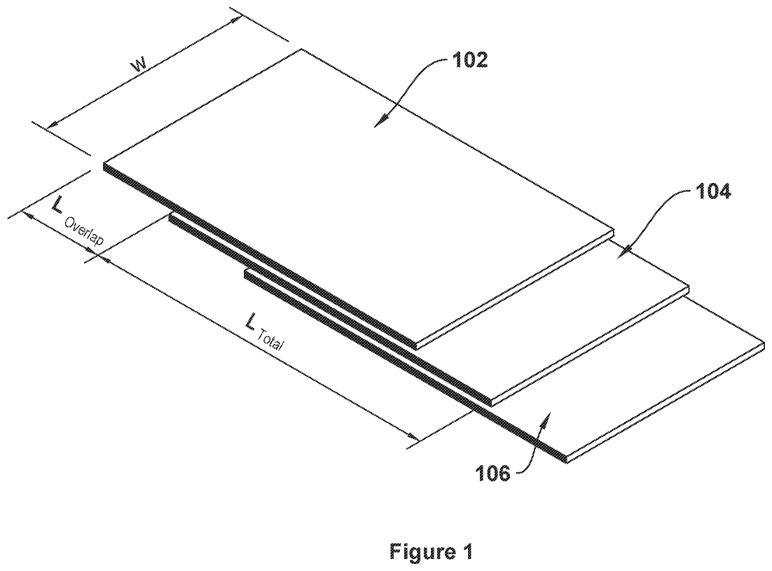

In FIG. 1, an example assembly of three layers (102, 104, 106) of three pieces of fabric is shown. A typical width of the fabric (W) is 2 to 4 feet, so each band of this fabric wrapped around the packer can repair a 2 to 4-ft long length of the pipe. The length of each layer of fabric must be the circumference of the pipe plus an overlap to ensure that once the SuperLaminate™ FRP is installed, its full strength in the hoop and longitudinal (axial) direction are realized.

In some embodiments, a single piece of fabric may be used and the length of the fabric will depend on the calculated number of layers required for strengthening the pipe. For example, if the pipe requires 3 layers of FRP, then the length of the fabric may be 3 times the circumference of the pipe plus an overlap length. But the installation of such a long piece of fabric may become impossible because when the packer pushes the fabric towards the inner wall of the host pipe often the fabric layers cannot unwind freely to stick to the inner surface of the pipe.

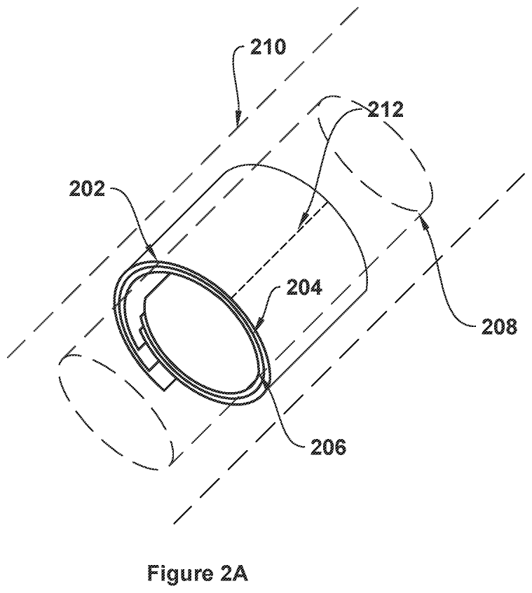

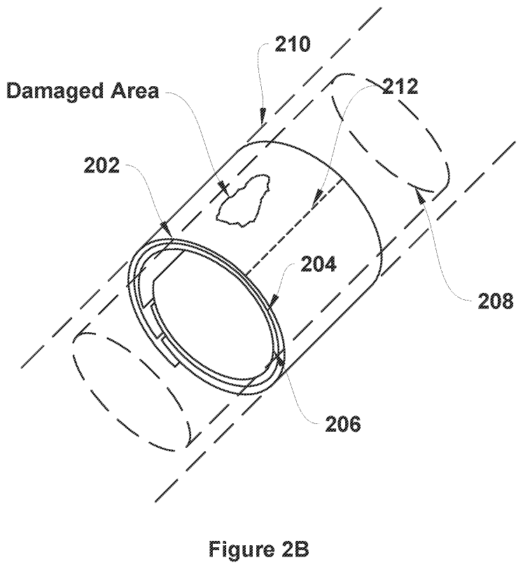

In an example, embodiment shown in FIG. 2A, three layers of fabric (202, 204, 206) are uniquely arranged and wrapped around a deflated packer 208 to move inside pipe 210 and reach the damaged area of pipe 210. FIG. 2B illustrates the three layers of fabric (202, 204, 206) of FIG. 2A, when packer 208 is inflated and the layers of fabric are pushed against the damaged area of pipe 210. Assuming pipe 210 has a 24-inch nominal diameter, the inside circumference of pipe 210 will be approximately 75 inches. If a 12-inch overlap length is required for the fabrics to fully develop their tensile strength, the top layer 202 of carbon fabric will have a length equal to the sum of L_{Overlap}=12 plus L_{Hoop}=75, where the total length will be L_{Total}=87 inches. The second and the third layers of carbon fabric (204 and 206) will also have a total length of approximately equal to 87 inches.

In repairing the steel pipes, it is recognized that allowing carbon fabric to come in contact with the steel will result in galvanic corrosion; therefore, a first layer of glass fabric is used as a dielectric barrier. These various fabric layers are properly arranged as illustrated and are held together with adhesive, staples, rivets, stitches 212, or the like, where each piece of fabric holds its position with respect to other layers during the entire repair process. One or more lines of stitches 212 may be applied at different locations of the bundle of fabrics/layers.

In various embodiments, fabrics 202, 204, and 206 may be saturated with resin. Resin may also be applied between these fabric layers. It can fully or partially saturate the fabric layers. Multiple layers of resin-saturated fabric can be wrapped around the packer and deployed together into the pipe. The number of layers of FRP fabric will be calculated based on the specifications of the fabrics, the characteristics of resin, and the pressure rating and other loads on the pipe. The saturated fabric layers are wrapped around a partially deflated packer. It is preferable to wrap a protective sheeting around this assembly to ensure that the epoxy does not rub off against the pipe surface while enroute to the point of repair. Such sheeting can be a plastic film or a bag that can be removed once the assembly reaches its destination.

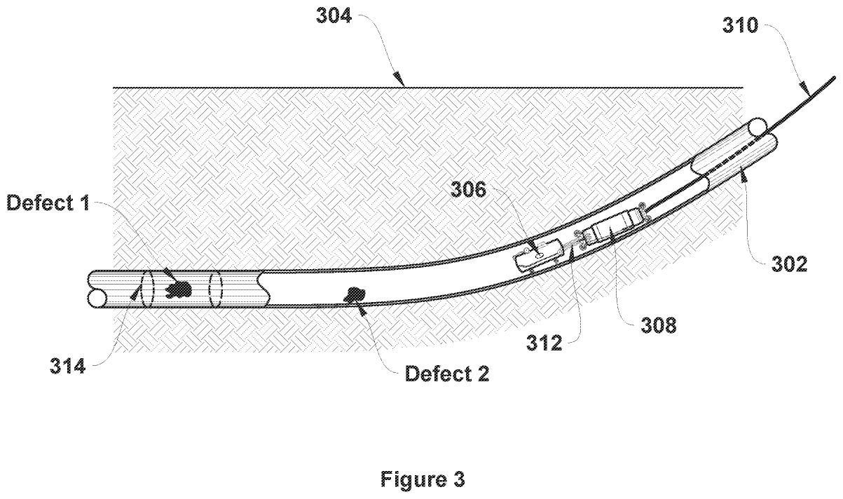

FIG. 3 shows a sample application for an O&G pipe where the access point is an inclined pipe 302. As shown, multiple defects can be repaired from the same access point over ground 304. A tethered crawler 306 is sent into pipe 302 which pulls (or pushes) the packer 308 and repair materials behind it (or in front of it), by a rope 312, to Defect #1. Once that defect is repaired by a multi-layer fabric 314, the tether 310 retracts the crawler 306 and packer 308 out of the pipe 302. Then in a similar fashion, the repair system is mobilized to Defect #2 which is closer to the entry launch point. This approach allows repairing multiple defects sequentially starting from the defect that is farthest to the entry point to the defect nearest the entry/launch point.

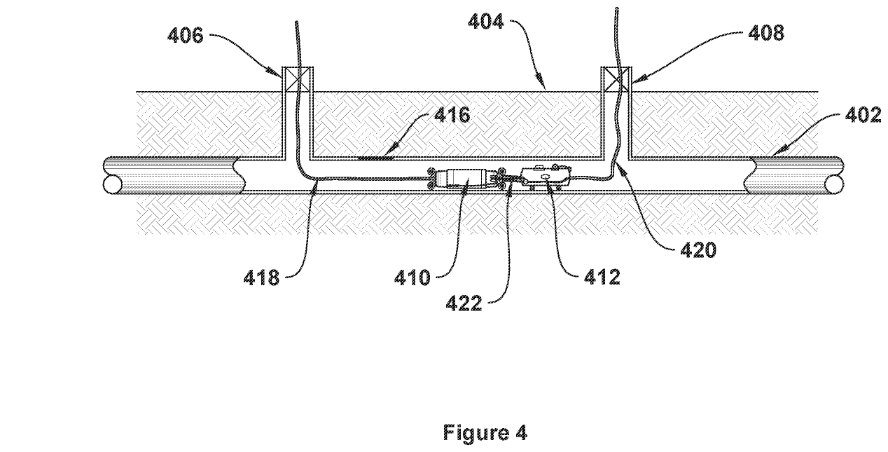

FIG. 4 illustrates a sample system for the repair of damaged pipe 402 with access holes 406 and 408, which is buried in soil (earth) 404 and has a defective region 416. Tractor 410 includes a motor that operates with fuel, electricity, compressed air, etc., and is powerful enough to pull behind it or push in front of it all the equipment such as the inflatable packer 412 and for example a compressed air tank or an air compressor. One or more cameras and lights may be mounted at various locations to assist with the positioning of the system and look for the exact location of the defect, inspect the repair quality, etc. In some embodiments tractor 410 may also have an air compressor that can be turned on and off remotely by wire or wirelessly. In other embodiments the compressed air tank and/or the air compressor may also be manipulated remotely by wire or wirelessly.

Considering the long distance the system has to travel to reach the point of repair (or defect), ordinary steel cables that are heavy may not be the best option for this application. Kevlar braided cables/ropes are an ideal product for this application. A rope with a diameter of 0.1 inch can resist 900 pounds of load and weighs less than 3 pounds per 1000 feet. A comparable strength steel cable would weigh at least 20 times more and would be nearly impossible to pull a 2-3-mile-long piece of that cable. Such cables 418 are used at various locations in the system, for example, to connect the tractor 410 to the packer 412, or the compressed air tank to the packer 412. In addition to the low weight, Kevlar ropes are much safer for such applications. Steel cables risk rubbing against the steel pipe and creating a spark that could lead to an explosion inside the pipe.

The Kevlar cables 418 and 420 may also incorporate fiber optic cables that allow remote controlling of the system from outside the pipe 402 as well as the collection of strain monitoring data from different strain gauges. A protective hose can also be employed to cover the fiber optic cable and the Kevlar cable 418 to prevent fraying and damage to the cable.

Once the inflatable packer reaches repair point 416, air is pushed into packer 412 through air tube 422. This forces the expansion of the packer 412 and the FRP fabric (SuperLaminate™) that is wrapped around it until these materials come in full contact with the inner surface of the host pipe 402. This pressure is maintained for as long as needed to cure the FRP (SuperLaminate™).

It is known by those skilled in the art that most epoxies cure faster when they are heated. So, to expedite the repair time, the SuperLaminate™ can be heated. This can be done in a number of ways. One way is by heating elements embedded in the silicon pads; other ways include heating the packer from the inside by hot air or steam. Such heating is particularly needed if the FRP fabrics are prepreg; these products require heating before the cross-linking and curing of the epoxy is initiated. Recently new resins have been developed by Prof. Robert Liska and his associates that at the push of a button the resin begins its curing process with a light source as described in the following paper:

https://ekaprdweb01.eurekalert.org/pub_releases/2020-03/vuot-erh030220.php

Such resins can also be used to accelerate the curing process. Another category of epoxies that can be used are those that are cured when exposed to UV light. In some embodiments the resin used is such that it is rapidly cured by passing an electrical or magnetic current through the resin.

Once the epoxy is cured, the deflating valve of the packer is opened and the air will leave the packer. At this point the deflated packer is free and can be pulled away from the repair point either by the tractor 410 or by using the Kevlar rope 418 attached to the packer assembly.

It is desired to monitor the strains and stresses in the pipe and the repair sleeve both upon installation and after some time in service. This can be done by embedding sensors such as strain gages or fiber optic sensors that transmit the strains by using a fiber optic cable or via radio transmission, e.g. cell phone signal to the monitors outside the pipe. Global positioning systems (GPS) can also be used to monitor and control the placement of the repair assembly and devices inside the pipe.

Those skilled in the art realize that variations of the proposed method can be used within the spirit of this invention. For example, the compressed air tank can be a small canister attached to the packer assembly. Likewise, wheels can be used to center the packer assembly or to facilitate the movement of the compressor and/or the packer.

A somewhat simpler technique for the repair of pipes does not require any motorized tractor. Pipe 402 which is buried in soil 404 is connected to a vertical access hole that ends with manhole 406 (e.g., manholes in sewers or fire hydrants, as a new access concept, in water mains) above ground. Pipe 402 also is connected to another access hole that ends with manhole 408 above ground. Defective point 416 that requires repair is between these two access holes 406 and 408.

With this technique, a lightweight Kevlar or similar ropes 418 and 420 are threaded into pipe 402 such that it enters from one access hole 408 and exits from the next access hole 406. The carrier ropes can be transferred using a remotely controlled pipe crawler or similar device from the first access hole to the next. The ropes can be winched back and forth between the access holes. The inflatable packer 412 is prepared as described earlier with the FRP SuperLaminate™ wrapped around it. One end of rope 418 is attached to the packer assembly. The other Kevlar or similar strong and lightweight rope 420 is attached to the other end of the packer assembly.

Either by hand or by using a winch, rope 418 is pulled and that causes the packer assembly to enter the pipe through the access hole 408. In this operation, rope 420 is not active. Pulling on rope 418, the packer assembly is moved to the defective spot 416. Alternatively, a pulley system can reduce tension and pulling force. Upon positioning the repair assembly (i.e., packer with the FRP repair sleeve), the packer 412 is inflated the same as described above by use of compressed air, steam, or heating elements (as described previously), light, etc. to start the repair process. The flexibility of the SuperLaminate™ FRP fabrics and packer allows this assembly to maneuver through 90-degree bends and thus the repair technique is trenchless (no-dig).

In some embodiments, the packer and FRP assembly can be inserted into a protective cover. One example of such a protective cover is a flexible pipe. These will protect the materials from rubbing against the inner surface of the pipe while moving from manhole 408 to 416 and potentially losing some of the epoxy or damaging the FRP fabric during transportation. At the same time, the flexibility of these protective covers will allow the assembly to negotiate sharp bends. In some embodiments, a separate cable can be attached to the end of the protective cover and once the assembly reaches point 416, the protective sleeve can be pulled away to allow the FRP to bond to the pipe.

In some embodiments, a series of wheels can also be connected (like a train) to create a flexible frame with multiple joints (hinges) to support the assembly during transportation and prevent the FRP to rub against the host pipe while it moves from point 408 to point 416. Such a support frame can also be pulled out of the way with an additional attached cable before the packer is inflated. This wheel assembly can also be connected to the protective sleeve (flexible hose) discussed above.

Once the FRP SuperLaminate™ is installed and cured, the deflated packer can be pulled out of pipe 402 from either access hole 406 or 408. All other components such as cameras and lights, heating elements, sensors, fiber optics, etc. described earlier can also be included in this system. One of the main advantages of the repair shown in FIG. 4 is its simplicity and low cost which is only limited by the length and weight of the strong cable/rope 418 used. It is possible to repair a spot that is several miles from an entry point with the described procedure.

In various embodiments, the epoxy can be of the type that is activated with water LED, UV or other light sources. Recent advances, for example by Professor Robert Liska at Vienna University of Technology have resulted in the development of a new generation of epoxies. By briefly flashing a UV light source, a chemical reaction begins that heats the local resin temperature to 200° C. and causes rapid curing of the resin. Unlike the old (traditional) UV-cured resins where the UV light must continue to remain as the source to provide the curing, in this case, the initial flashing of UV light heats the resin and from that point on, the resin generates the heat that expedites the curing (without any further need for the UV light source). Traditional UV-cured resins work on glass fiber FRP only; the black color carbon fibers block the UV light and thus cannot be used for conventional UV-cured resins. The new system does not have that limitation since it is the heat generated in the resin itself (and the UV light) that continues the curing process.

In various embodiments, sensors such as strain gages, temperature sensors, etc. can be added to or embedded within the SuperLaminate™ to allow real time monitoring of the stresses, temperature, and other characteristics of the pipe during the pipe's service life. These sensors can transmit the time and date to monitors outside the pipe using cables or remote (wireless) signals.

The SuperLaminate™ FRP liner is so thin that it hardly reduces the inside diameter of the pipe or introduces any protrusions to the interior, with a smooth finish along the edges. This makes the repair system compatible with cleaning and inspection equipment used in the pipeline industry In fact, in most cases, the smooth surface of the repair system improves the flow through the pipe by reducing the friction in that repaired region. In other words, the smooth surface more than compensates for the small loss in diameter, resulting in a net gain in flow characteristics of the pipe after repairs are completed.

In various embodiments, the truck and the packer, and other mobile instruments may be controlled completely wirelessly. In such embodiments camera and other sensor signals are sent wirelessly by the mobile system to the control center on the ground and control signals are transmitted wirelessly to the mobile system from the control center. In some embodiments, the mobile system may include two trucks at both ends to pull and/or push the system from both ends, as needed.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B,” and also the phrase “A and/or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments but is intended to cover various arrangements included within the spirit and scope of the broadest interpretation so as to encompass all such modifications and equivalent arrangements.

1. A no-dig method of repairing a damaged pipe, from inside, the method comprising:
placing more than one piece of at least partially resin-impregnated fabrics of similar size over each other to form a fabric-laminate, such that the fabrics fully overlap each other in a first direction and partially overlap each other in a second direction that is perpendicular to the first direction, wherein both edges of the fabrics in the second direction form two stairways at each end of the fabric-laminate, and wherein a rise-height of each stair is a thickness of one of the fabrics and a tread-depth of each stair is a calculated-overlap-length of each fabric when formed into a hoop with overlapped ends;
stitching or bonding the fabrics together such that the fabrics cannot move with respect to each other in the first direction;
wrapping, in the second direction, the stitched or bonded fabrics around a packer;
moving the packer into the damaged pipe and positioning the packer adjacent to the damaged area of the pipe;
inflating the packer to force the fabrics against the damaged area of the pipe, wherein the fabric layers form concentric individual and distinct cylinders, and wherein each cylinder is formed by a single layer of fabric with the calculated overlap;
deflating the packer; and
removing the packer from the pipe or moving the packer to another point of repair.

2. The method of claim 1, wherein the fabrics are resin-saturated and nonmetallic.

3. The method of claim 1, wherein the packer is pulled or pushed with a rope or by a mechanized cart to a point of repair in the pipe.

4. The method of claim 1, wherein the packer is inflated via a remote activating mechanism to push the fabrics against an interior surface of the pipe.

5. The method of claim 1, wherein the fabric-laminate is cured in place after packing.

6. The method of claim 1, wherein the fabric is made of carbon, glass, Kevlar, and basalt FRP fabrics.

7. The method of claim 1, wherein curing of the resin is accelerated by electrical current, magnetic field, heat, UV, or other types of light.

8. The method of claim 1, wherein various layers of the fabric-laminate are FRP products.

9. The method of claim 1, including the additional step of cleaning and preparing the interior surface of the pipe before installation of the fabric-laminate.

10. The method of claim 1, wherein sensors are embedded in the fabric-laminate to monitor stresses during service life of repair.

11. A method of repairing a damaged pipe, from inside the pipe, the method comprising:
placing more than one piece of at least partially resin-impregnated fabric over each other to form a fabric-laminate;
stitching or bonding the fabrics together such that the fabrics cannot move with respect to each other in a first direction but can slide over each other in a second direction if the layered fabrics are bent, wherein the second direction is substantially perpendicular to the first direction, and wherein both ends of the fabrics in the second direction form two stairways at two ends of the fabric-laminate, and wherein a rise-height of each stair is a thickness of one of the fabrics and a tread-depth of each stair is a calculated-overlap-length of each fabric when formed into a hoop with overlapped ends;
wrapping, in the second direction, the stitched or bonded layered fabrics around a packer;
pulling and/or pushing the packer into the pipe and positioning the packer in the damaged area of the pipe;
expanding the packer to force the fabrics to attach to damaged inner walls of the pipe, wherein the fabric layers form concentric individual and distinct cylinders, each formed by a single layer of fabric with the calculated overlap; and
deflating the packer to be moved away from point of repair.

12. The method of claim 11, wherein the fabrics are resin-saturated and nonmetallic.

13. The method of claim 11, wherein the packer is pulled or pushed with a rope or by a mechanized cart to a point of repair in the pipe.

14. The method of claim 11, wherein the packer is inflated via a remote activating mechanism to push the fabrics against an interior surface of the pipe.

15. The method of claim 11, wherein the fabric is made of carbon, glass, Kevlar, and basalt FRP fabrics.

16. The method of claim 11, wherein curing of the resin is accelerated by electrical current, magnetic field, heat, UV, or other types of light.

17. The method of claim 11, wherein various layers of the fabric-laminate are FRP products.

18. The method of claim 11, including the additional step of cleaning and preparing the interior surface of the pipe before installation of the fabric-laminate.

19. The method of claim 11, wherein sensors are embedded in the fabric-laminate to monitor stresses during service life of repair.

20. A method of patching a damaged area of a pipe from inside the pipe, the method comprising:
placing at least two pieces of fabric over each other;
stitching or bonding the at least two fabrics together such that the fabrics cannot move with respect to each other in a first direction but can slide over each other in a second direction if the at least two fabrics are bent in the second direction, wherein the second direction is substantially perpendicular to the first direction, and wherein both edges of the at least two fabrics in the second direction form two stairways, and wherein a rise-height of each stair is a thickness of one of the fabrics and a tread-depth of each stair is a calculated overlap length of each fabric when formed into a hoop with overlapped ends;
forming the layered fabrics into a cylinder that can be moved within the pipe, wherein a longitudinal axis of the cylinder is in the first direction;
moving the formed cylinder into the damaged pipe and positioning the formed cylinder in the damaged area of the pipe; and
expanding the formed cylinder and pushing the layered fabrics against damaged inner walls of the pipe, wherein the fabric layers form concentric individual and distinct cylinders, each formed by a single layer of fabric with a predetermined overlap.
